(19) United States
(12) Patent Application Publication
(10) Pub. No.: US 2005/0105877 A1
(43) Pub. Date: May 19, 2005

(54) Optical fiber illuminators having integral distal light diffusers especially useful for ophthalmic surgical procedures, and methods of making the same

(75) Inventors: Richard B. Nappi, Durham, NC (US); Ronald F. Overaker, Durham, NC (US); Cynthia A. Toth, Chapel Hill, NC (US); Brian C. Dodge, Durham, NC (US); Hoang Ngyuen, Durham, NC (US); Katrina P. Winter, Wendell, NC (US)

Correspondence Address: NIXON & VANDERHYE, PC, 1100 N GLEBE ROAD, 8TH FLOOR, ARLINGTON, VA, 22201-4714, US

(73) Assignee: Duke University, Durham, NC (US)

(21) Appl. No.: 10/706,269

(22) Filed: Nov. 13, 2003

(51) Int. Cl. G02B 6/00

(52) U.S. Cl. 385/140; 385/139

(57) ABSTRACT

Optical fiber illuminators are embodied in light-diffusing particles affixed to an optical fiber's terminal end. Most preferably, the light-diffusing particles are optically transparent solid particles dispersed symmetrically or asymmetrically in an optically transparent bonding material to thereby form a light diffusion medium (LDM). The solid particles may thus be dispersed in the bonding material while the bonding material is in a liquid state to form the LDM. A mass of the LDM may thus be applied onto the terminal optical fiber end while the bonding material is in such a liquid state. Allowing the bonding material to solidify will therefore affix the light-diffusing particles to the terminal end of the optical fiber. In such a manner, optical fiber illuminators having high light throughput and diffusion may be made.

### FIELD OF THE INVENTION

The present invention relates generally to the field of optical fiber illuminators, that is, optical fibers which guide light from a remote light source to a terminal end of the optical fiber so as to provide desired illumination. In especially preferred forms, the present invention relates to fiber optic illuminators that have particular utility in the medical field, such as, to illuminate a surgical site, especially during ophthalmic surgical procedures.

### BACKGROUND AND SUMMARY OF THE INVENTION

Current fiber optic illumination used for intra ocular surgery includes a range of fiber optic options such as plain blunt fiber tips, round ball, cannonball, bullet tip probes with a modified curvature of the tip for diffusion, or an individual lens separate from the fiber to create diffusion. These prior proposals allow for fiber optic guided light to be directed into the eye, and in the case of the two latter examples noted previously, there is improved diffusion of the light within the eye.

In those cases where the tip of the probe is modified to create a conically-shaped or rounded tip, diffusion occurs but there is focusing of the light distal to the tip. Focussing of light is less than satisfactory during ophthalmic surgical procedures as it can increase the risk of retinal exposure to high energy if the tip is moved close to the retina. Conically-shaped or rounded tip geometries for fiber optic probes do however posses good light throughput because there is substantially no loss due to the added air space and second lensing system.

Recently a fiber optic probe which utilizes a separate focusing or diffusion lens has been proposed in U.S. Pat. No. 5,624,438 to Turner (the entire content of which is incorporated expressly hereinto by reference). Such a conventional fiber optic probe, however, has the possibility of focusing down and having higher intensity light on the retina, however some systems use a holographically manufactured micro lens array that diffuses the illumination without having any focal spot of intense radiance. Such a lens system however, requires some complex manufacturing steps to position the fiber and the lens within the same instrument. Moreover, it has some restrictions because the space between the fiber and lens needs to remain fluid-free and there is throughput loss at the fiber optic-to-air-to-lens interfaces.

What has therefore been needed are fiber optic probes which exhibit good light throughput and little, if any, light focussing. That is, what has been needed are fiber optic probes which have both high light throughput and diffusion. Such fiber optic probes would thus find particular utility in the field of ophthalmic surgical procedures. It is towards providing such fiber optic probes that the present invention is directed.

Broadly, the present invention is embodied in optical fiber illuminators which possess high light throughput and diffusion, and in methods of making such illuminators. The illuminators of the present invention are therefore especially usefully employed in the surgical field, generally and, more specifically, in the field of ophthalmic surgical procedures.

In especially preferred forms, the present invention is embodied in optical fiber illuminators comprised of an optical fiber and light-diffusing particles affixed to the optical fiber's terminal end. Most preferably, the light-diffusing particles are optically transparent solid particles dispersed symmetrically or asymmetrically in an optically transparent bonding material to thereby form a light diffusion medium (LDM). The solid particles may thus be dispersed in the bonding material while the bonding material is in a liquid state to form the LDM. A mass of the LDM may thus be applied onto the terminal optical fiber end while the bonding material is in such a liquid state. Allowing the bonding material to solidify will therefore affix the light-diffusing particles to the terminal end of the optical fiber. In such a manner, optical fiber illuminators having high light throughput and diffusion may be made.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawings, wherein like reference numerals throughout the various FIGURES denote like structural elements, and wherein;

FIG. 1 is a schematic illustration of a surgical light system having a handpiece provided with a fiber optic illuminator in accordance with the present invention;

FIGS. 2A and 2B are enlarged close-up views of one exemplary embodiment of the tip of the fiber optic illuminator in accordance with the present invention wherein FIG. 2A is an enlarged perspective view of the illuminator tip and FIG. 2B is a cross-sectional elevational view of the tip as taken along line 2B-2B therein;

FIGS. 3A and 3B are enlarged close-up views of another embodiment of the fiber optic illuminator tip in accordance with the present invention wherein FIG. 3A is an enlarged perspective view of the illuminator tip and FIG. 3B is a cross-sectional elevational view of the tip as taken along line 3B-3B therein;

FIGS. 4-6 are each cross-sectional elevational close-up views of further exemplary fiber optic illuminator tips in accordance with the present invention;

FIG. 7 is a plot of normalized light intensity versus angular measure of several fiber optic illuminators in accordance with the present invention in comparison to several conventional fiber optic illuminators; and

FIG. 8 is a plot of intensity versus radial distance showing a normalized comparison among selected fiber optic illuminators of the present invention and selected conventional fiber optic illuminators.

### DETAILED DESCRIPTION OF THE INVENTION

### A. DEFINITIONS

As used herein and in the accompanying claims, the terms below are intended to have the following definitions:

“Optically transparent” and/or “optical transparency” means at least about 70%, more preferably at least about 90%, and most preferably at least about 95%, up to about 100%, transparent to visible light.

“Average particle diameter” is the numerical average of particle diameters of the smallest spheres which completely surround respective individual particles. Thus, for example, for spherical particles the average diameter will be equal to the numerical average of the particle diameters per se, whereas for ellipsoid particles, the average diameter will be the numerical average of spheres whose diameters are equal to the major axes of the particles.

“Light diffusion profile” is the percent of light intensity present at an angle of 60° relative to the optical fiber centerline (0°). Thus, a greater percent light intensity at 60° is indicative of a greater diffusion capability for the optical fiber and vice versa.

### B. DESCRIPTION OF PREFERRED EXEMPLARY EMBODIMENTS

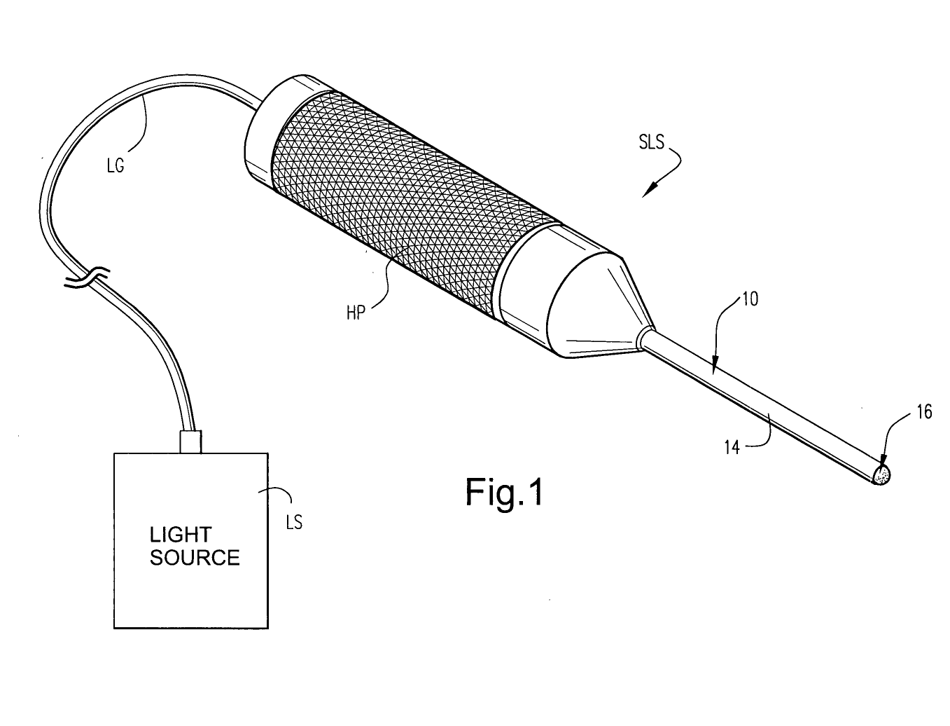

A surgical light system SLS for illuminating a surgical field, for example, during an intra-ocular surgical procedure is schematically depicted in accompanying FIG. 1. The surgical light system SLS generally is comprised of a handpiece HP sized and configured to allow manual manipulation by a surgeon so as to direct the light emanating from the fiber optic illuminator 10 in accordance with the present invention. A primary light guide LG optically connects the remotely located light source LS and the fiber optic illuminator 10. Alternatively, the light source LS may be self-contained within the handpiece HP, in which case the primary light guide LG is not needed. The fiber optic illuminator 10 of the present invention may be employed in conventional handpieces and surgical light systems, for example, the handpieces and light systems disclosed in U.S. Pat. Nos. 6,270,491, 6,536,035 and 6,540,390 each to Toth et al (the entire content of each patent being expressly incorporated hereinto by reference).

Accompanying FIGS. 2A and 2B show one particularly preferred embodiment of the fiber optic illuminator 10 in accordance with the present invention. In this regard, the fiber optic illuminator is comprised of an optical fiber 12 which is encased along its length by a support tube 14. A light diffusion medium (LDM) 16 is affixed to the tip region 12-1 of the optical fiber 12. Specifically, the LDM is comprised generally of a bonding material 18 containing a homogeneous dispersion of light-diffusing particles 20.

Any conventional optical fiber 12 may be employed in the practice of this invention. Thus, conventional optical fibers formed from glass, acrylic, polycarbonate and like materials may be satisfactorily employed. The particular diameter of the optical fiber 12 will depend on the desired end use application. For surgical applications, however, diameters of between 125 μm to about 750 μm are typically advantageous. Multiple individual optical fibers, particularly those of smaller diameter, may be bundled together, in which any number or all of the fibers in the bundle may comprise a light diffusion medium 16 in accordance with the present invention. One particularly preferred optical fiber is #812-1421-002 commercially available from Alcon Laboratories, Inc. of Fort Worth, Tex.

The bonding material 18 is optically transparent once it hardens and most preferably is substantially optically matched to the optical properties of the fiber 12. In this regard, the bonding material 18 most preferably has an index of refraction (n) which is substantially similar to the index of refraction exhibited by the optical fiber 12. That is, the index of refraction of the bonding material is such that the Fresnel reflection at the interface between the optical fiber tip and the bonding material is less than about 5%, and more preferably less than about 1%, of the total light throughput. Most preferably, the difference in the refractive indices (Δn) between the bonding material 16 and the optical fiber 12 is less than about 15%, and more preferably less than about 5%. In preferred embodiments of this invention, the index of refraction difference (Δn) between the bonding material 16 and the optical fiber 12 is most preferably less than about 3%. Especially preferred for use in the present invention are optically transparent epoxy materials, particularly those commercially available from Epoxy Technology under the tradename “EPOTEK”.

The solid light-diffusing particles 20 are likewise optically transparent and have an index of refraction which is substantially different than that of the bonding material 18 in which the particles 20 are embedded. The light-diffusing particles may thus be formed of any optically transparent material, such as glasses (e.g., optically transparent silica), and/or plastics such as optically transparent polycarbonates, epoxy resins, fluoropolymers (e.g., TEFLON™ AF, duPont), and the like.

The particular geometric shape of the particles 20 is not particularly critical as a variety of symmetrical, asymmetrical, regular and/or irregular solid geometric shapes may be employed alone or in admixture to achieve the desired light throughput and diffusion properties. Thus, solid spheres, ellipsoids, cubes, polygons, tetrahedrons, and like geometries may be employed in addition to or in admixture with particles having irregular surface characteristics.

The size of the light diffusing particles 20 is likewise chosen for desired light throughput and diffusion characteristics of the fiber optic illuminator in accordance with this invention. The lower limit of the average particle size is determined by a number of factors, for example, the physical constraints of the material from which the particles 20 are made. In addition, the more the average particle size of the particles 20 approaches the wavelength of visible light, the more the particles will then be wavelength dependent which is disadvantageous in the context of light illuminators for use in surgical applications. However, in the fiber optic illuminators for use in ophthalmic surgical procedures which are presently preferred embodiments of this invention, the light-diffusing particles 20 that are employed will typically have average particle sizes on the order of at least about 1.0 μm, and more preferably at least about 5.0 μm.

In practical terms, the average particle diameters of the light diffusing particles 20 are less than about 10.0 μm. Theoretically, however, the average particle diameter should not be greater than about one-half (½), and more preferably not greater than about one-fourth (¼), the diameter of the optical fiber 12. When embodied as a fiber optic illuminator for ophthalmic surgical procedures, the optical fiber 18 will typically not have a diameter greater than about 750 μm. Thus, the practical upper limit of the average particle diameters of the light-diffusing particles 20 when employed in such embodiments will usually be less than about 375 μm, and preferably less than about 185 μm. Mixtures of different particle geometries and/or different particle sizes may be employed also to achieve desired light throughput and diffusion characteristics.

The light-diffusing particles 20 are most preferably present as a homogenous dispersion of “islands” in a “sea” of the bonding material 18. However, in some applications, it may be desirable to asymmetrically “load” a region of the bonding material at the tip of the optical fiber 12 so as to achieve desired light throughput and/or diffusion characteristics. Advantageously, the light-diffusing particles 20 will be present in the bonding material 18 in an amount of less than about 90 vol. %, more preferably less than about 60 vol. %, and usually less than about 30 vol. %.

The amount of light-diffusing particles 20 which is dispersed in the bonding material 18 is selected so that the fiber optic probe 10 exhibits the desired light diffusion profile. Thus, the less amount of light-diffusing particles 20 that are dispersed in the bonding material 18, the less diffusion of emitted light will occur. Thus, in practical terms, the amount of light diffusing particles 20 that is dispersed in the bonding material 18 of the light diffusion medium 16 is such that a light diffusion profile of at least about 1.25 times, preferably about 1.5 times, and most preferably at least about 2 times, as compared to the same optical fiber which does not have the light diffusing medium 16 affixed to the distal tip thereof. Thus, a greater percentage of the emitted light will be present at 60° for the optical fibers modified to have the light diffusion medium 16 in accordance with the present invention as compared to the same plain or unmodified optical fiber.

The layer thickness of the light diffusion medium 16 is selected so as to achieve desired light throughput and/or a diffusion properties. In this regard, the layer thickness as measured between the distal tip surface parallel to the fiber optic center axis to the maximum distal region of the light diffusion medium 16 is most preferably between about 25 μm to about 250 μm, preferably between about 50 μm to about 150 μm. Advantageously, the layer thickness of the light diffusion medium 16 is about 75 μm.

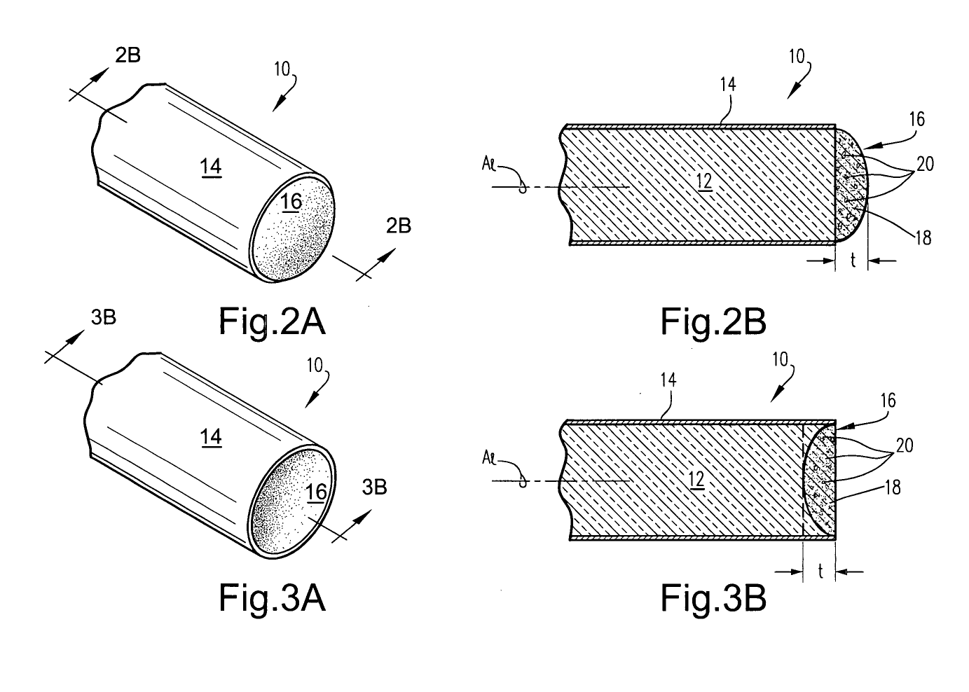

Accompanying FIGS. 2A and 2B depict the LDM 16 as having a smooth covexly curved exterior surface which is affixed to a terminal end surface of the optical fiber 12 which is perpendicular to the fiber's elongate axis A₁. The fiber optic probe 10 of the present invention may, however, be embodied in a large variety of surface geometries or configurations of the terminal fiber end and/or LDM 16. Such geometry variations are depicted in accompanying FIGS. 3A and 3B and FIGS. 4-6.

As seen in FIGS. 3A and 3B, the fiber optic probe 10 comprises an optical fiber 12 having a concave recess at its terminal end in which the LDM 16 is filled. The extent of the recessed terminal fiber end will thus determine the thickness t of the LDM 16. The LDM 16 is also depicted as having a perpendicular terminal exterior surface. Alternatively, as shown in dashed line in FIG. 3B, the LDM 16 could be in the form of a substantially right cylinder having the thickness t.

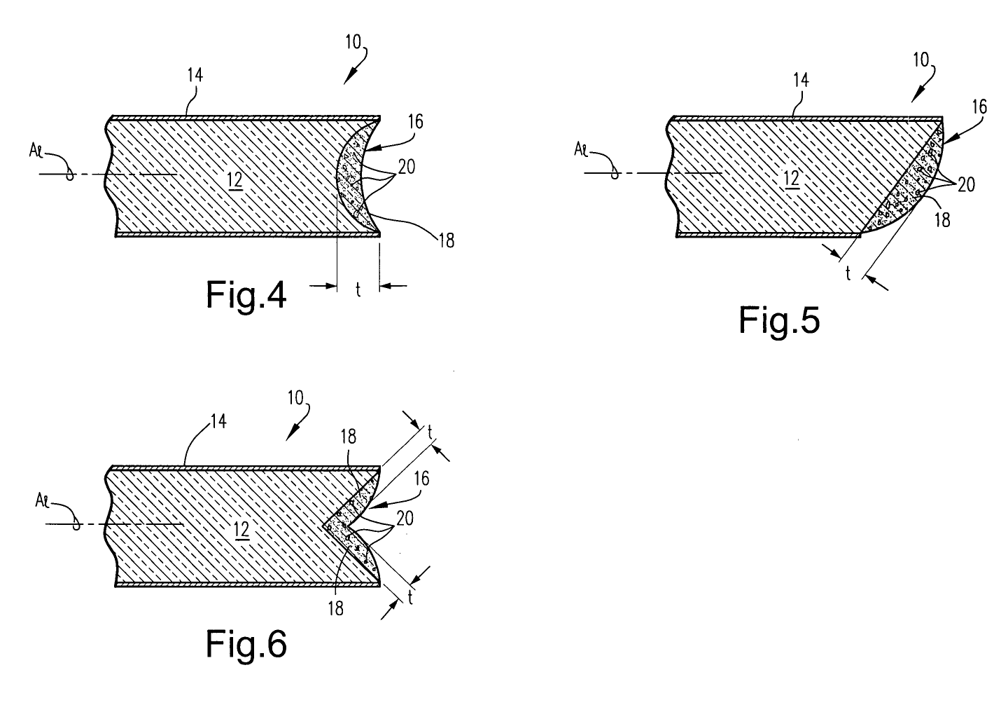

FIG. 4 is similar to the embodiment depicted in FIG. 3B, except that the terminal exterior surface of the LDM 16 is similarly concave. FIG. 5 depicts an embodiment wherein the terminal end surface of the fiber 12 to which the LDM 16 is affixed is angled (e.g., about 45°, whereas the LDM 16 is generally spherically shaped. FIG. 6 depicts an embodiment wherein the terminal end of the optical fiber 12 includes a V-shaped notch having respective surfaces to which is affixed a respective generally convexly formed masses of LDM 16. Other specific structural embodiments of the present invention can be realized by those skilled in the art to achieve virtually any desired emitted light characteristic.

The present invention will be further understood from the following non-limiting Examples.

### EXAMPLES

1. Diffusion Fiber Manufacturing Technique:

20 fiber optic light guides (FOLGs) commercially obtained from Alcon Laboratories, Inc. of Fort Worth, Tex. (#812-1421-002), were wet lapped using first 320 grit sandpaper and then 600 grit sandpaper to ensure that the fiber optic probe tips were flat and thereby provide maximum efficiency and allow for strong adhesion. After lapping, each fiber was then measured for maximum light throughput using an EG&G, model 555-75 integrating sphere in conjunction with a Lutron, model LX-101, Lux meter. The fibers were then each assigned one of the possible combinations of the letters A through E and the numbers 2, 5, 10, and 20 to allow for future identification. The number designations corresponded to the thickness, in thousandths of an inch, of the light diffusing medium that would be applied to each FOLG. Therefore, five fibers each provided with a light diffusing medium layer thickness of 2 thousandths of an inch (0.002″), 5 thousandths of an inch (0.005″), 10 thousandths of an inch (0.010″), and 20 thousandths of an inch (0.020″) were to be made.

The light diffusion medium (hereinafter “LDM”) to be applied to the distal tip of the FOLGs was created by diluting equal volumes (approx. 0.010 cc) of 10 micron silica and EPOTEK™ 301 epoxy resin (Epoxy Technology of Billerica, Mass.) and hardener with ethanol to allow for easy mixing. The volumes of silica and epoxy were weighed prior to being mixed. The ethanol diluted LDM was then de-gassed under vacuum.

Silicone-rubber tubing molds were created for each FOLG using a lathe to cut the tubing to ensure a flat edge. The rubber tubing molds were placed over the tips of each FOLG and were adjusted under microscope to the appropriate position so that the end of the rubber tube mold extended beyond the FOLG tip by the appropriate distance for each FOLG to be made. Thus, the end of the rubber tube mold extended beyond the fiber optic tip a distance of 0.002″ for a fiber labeled “2”, a distance of 0.005″ for a fiber labeled “5”, etcetera. The de-gassed LDM was then placed in to the rubber-tubing mold under microscope examination so as to fill the generally cylindrical space between the tip of the FOLG and the end of the mold, and allowed to dry over night.

The FOLGS were then analyzed under microscope for irregularities and were cleaned, and actual LDM depths were measured.

2. Diffusion Fiber Testing:

(i) Angular Intensity Jig:

A clear polycarbonate tube was filled with water in order to simulate the light dispersion that would take place within a human eye. A small hole was drilled into the tube where the fiber optic probes would be inserted. The tube was set inside an acrylic ring which had been machined so that any light impinging on the inside of the ring perpendicularly would be reflected up through the circular cross-sections of the ring. The surface of the ring was frosted in order to scatter light on exit for easier photographing.

For a fiber optic light inserted into the water-filled polycarbonate tube, light propagated out in a pattern that was the same as in vitreous. Since the polycarbonate tube was cylindrical, light rays that propagated in a direction perpendicular to the tube passed straight through the tube, while rays propagating at an angle other than 0 degrees relative to the normal of the cylinder exited the tube at even a greater angle because the water-filled tube had a greater index of refraction than air. Thus, by covering the acrylic ring with black tape at all areas other than the cross-section that is concentric with the cross-section of light which leaves the polycarbonate tube perpendicularly, only those light rays that were propagating normal to the tube could be selectively observed. As a result, a representative 2-D cross-sectional radial sampling of the 3-D cone of light rays that left the fiber optic tip was obtained.

(ii) Testing Procedures:

The light throughput of each FOLG was measured using the integrating sphere and Lux meter with the tip of the fiber at the threshold of the integrating sphere and also with the tip of the fiber inserted 20 mm into the integrating sphere. The unitless numerical output of the Lux meter was noted at each fiber position in the integrating sphere which represented a value proportional to the total light emitted by the fiber tip.

Each fiber was then placed in the angular intensity jig and the angular intensity was photographed with identical placement and magnification using a digital camera, which was set manually to a focal length of 0.3 m, an F-stop of 4.0, and a shutter speed of 1/640 of a second. The photographs were in 8-bit grayscale, meaning that each pixel could attain a value of 0 to 255 where 0 is black and 255 is white.

A radial spoke figure consisting of overlapping black and white lines separated by 10 degrees was created using Deneba System's Canvas drawing program. This radial spoke drawing was then overlaid onto each radial intensity photograph, which had been gaussian blurred at a radius of 4 pixels. Using ImageJ software, the angular intensity photographs were straightened using ImageJ's “straighten” plug-in which creates a 20 pixel wide linear image of a curve that the user traces. Each straightened intensity picture was then adjusted so that they were of equal length and had equal angle to pixel ratios (i.e. so that 1 pixel horizontally corresponded to an angular measure of 0.119 degrees). These images were then analyzed using ImageJ's plot profile feature and the text file list which gives an average value of the 20 vertical pixels for any given horizontal pixel index was created. These text files were then converted into a spreadsheet (Microsoft Excel) that allowed the pixel intensity lists to be converted to intensity versus angle lists. Raw data values were obtained for all 20 prototype diffusion fibers, one optical fiber that was not modified at the tip to include LDM (hereinafter referred to as “Plain” fiber”), one conventional wide angle diffusion optical fiber (Alcon Grieshaber AG, Model 630.45, hereinafter referred to as “Wide Angle DF”), and one conventional “bullet” diffusion fiber (Alcon Grieshaber AG, Model #8065109202, hereinafter referred to as “Bullet” fiber). Normalized data values were also created for the 20 LDM-modified fibers by dividing intensity values by the maximum intensity for each individual fiber before having the LDM applied thereto.

The testing results are shown in Table 1A below.

TABLE 1A
(Invention)

| | | Post-Manufacturing Throughput | | | | | | | | | |
|---|---|---|---|---|---|---|---|---|---|---|---|
| | Initial | Threshold Location | | | | | 20 mm Location | | | | |
| Optical Fiber | Throughput | 1 | 2 | 3 | AVG | % of initial | 1 | 2 | 3 | AVG | % of initial |
| 2 mil LDM | | | | | | | | | | | |
| A | 85 | 75 | 75 | 74 | 74.7 | 88% | 75 | 75 | 75 | 75.0 | 88% |
| B | 93 | 72 | 72 | 70 | 71.3 | 77% | 72 | 72 | 71 | 71.7 | 77% |
| C | 92 | 75 | 72 | 75 | 74.0 | 80% | 75 | 72 | 75 | 74.0 | 80% |
| D | 85 | 80 | 79 | 82 | 80.3 | 95% | 80 | 80 | 82 | 80.7 | 95% |
| E | 91 | 85 | 85 | 88 | 86.0 | 95% | 85 | 85 | 88 | 86.0 | 95% |
| 5 mil LDM | | | | | | | | | | | |
| A | 80 | 46 | 45 | 47 | 46.0 | 58% | 50 | 49 | 50 | 49.7 | 62% |
| B | 83 | 56 | 57 | 58 | 57.0 | 69% | 63 | 65 | 64 | 64.0 | 77% |
| C | 81 | 55 | 47 | 48 | 50.0 | 62% | 57 | 51 | 52 | 53.3 | 66% |
| D | 80 | 59 | 60 | 62 | 60.3 | 75% | 63 | 65 | 67 | 65.0 | 81% |
| E | 77 | 65 | 66 | 67 | 66.0 | 86% | 68 | 68 | 70 | 68.7 | 89% |
| 10 mil LDM | | | | | | | | | | | |
| A | 61 | 28 | 27 | 27 | 27.3 | 45% | 33 | 32 | 32 | 32.3 | 53% |
| B | 80 | 51 | 50 | — | 50.5 | 63% | 63 | 62 | — | 62.5 | 78% |
| C | 71 | 56 | 54 | 57 | 55.7 | 78% | 63 | 63 | 63 | 63.0 | 89% |
| D | 90 | 58 | 58 | 62 | 59.3 | 66% | 65 | 67 | 69 | 67.0 | 74% |
| E | 85 | 51 | 52 | 53 | 52.0 | 61% | 62 | 62 | 65 | 63.0 | 74% |
| 20 mil LDM | | | | | | | | | | | |
| A | 90 | 52 | 49 | 54 | 51.7 | 57% | 67 | 64 | 68 | 66.3 | 74% |
| B | 86 | 49 | 46 | 49 | 48.0 | 56% | 59 | 64 | 63 | 62.0 | 72% |
| C | 86 | 50 | 56 | 50 | 52.0 | 60% | 66 | 72 | 68 | 68.7 | 80% |
| D | 88 | 87 | 88 | 87 | 87.3 | 99% | 87 | 88 | 87 | 87.3 | 99% |
| E | 84 | 42 | 47 | 46 | 45.0 | 54% | 60 | 60 | 63 | 61.0 | 73% |

Note:
No further results for fibers identified as 2E, 10B and 20D were subsequently recorded as such fibers were damaged during manufacturing and testing.

For purpose of comparison, data for the Plain, Bullet and Wide Angle DF fibers appear below in Table 1 B:

TABLE 1B
Plain, Bullet, Wide Angle DF Fiber Data (Comparative)

| | Throughput at | | Throughput at | % |
|---|---|---|---|---|
| Fiber Type | Threshold | % of Plain | 20 mm | of Plain |
| Plain | 83 | 100% | 83 | 100% |
| Bullet | 44.6 | 54% | 57.6 | 69% |
| Wide Angle DF | 33.3 | 40% | 36 | 43% |

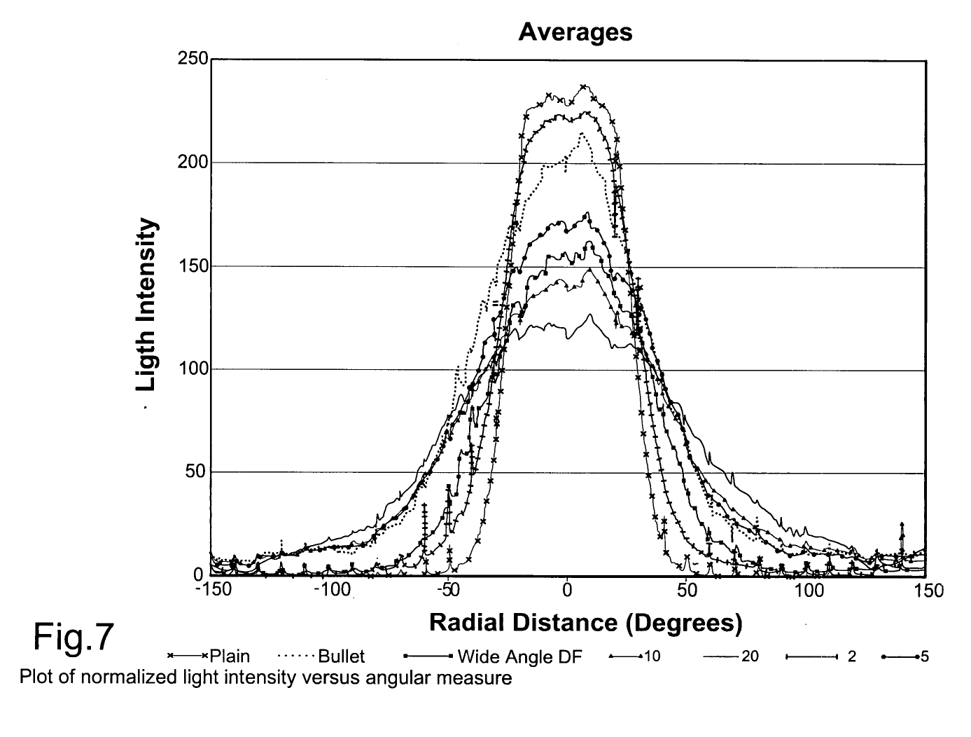

Accompanying FIG. 7 shows a plot of light intensity versus radial distance. Specifically, the vertical axis of FIG. 7 relates the average 8-bit pixel intensity while the horizontal axis represents the angle relative to a straight line down from the fiber tip. The data in FIG. 7 has been normalized by the initial throughput of each fiber. For the Plain fiber, Grieshaber DF fiber, and Bullet fiber, the average initial intensity of all other fibers was used for the normalization factor. The units on the vertical axis of the graph are arbitrary.

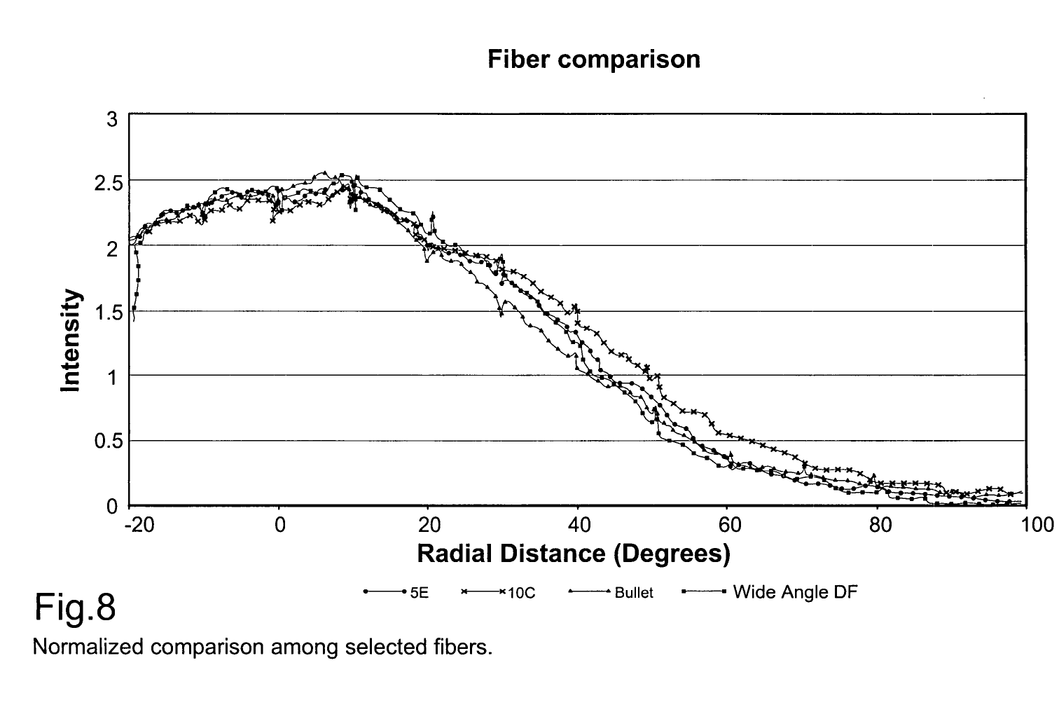

Accompanying FIG. 8 shows a smaller range of angles and fibers, with the throughputs normalized to average intensity in the −10 to zero interval. It should be noted that the intensity for the optical fibers in accordance with the present invention (i.e., those having been modified by the LDM affixed to the tip thereof), fibers 5E and 10C are higher than the Bullet fiber at angles between 20 and 40 degrees, and comparable or greater than the Grieshaber DF fiber at angles greater than 40 degrees. The data in FIGS. 7 and 8, combined with the total throughput from Tables 1A and 1B above, demonstrate that that the optical fibers in accordance with the present invention achieve better performance than current diffusion fiber technology. More specifically, the fiber optic illuminators in accordance with the present invention achieve both high light throughput with relatively wide angle dispersion

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An optical fiber illuminator comprising an optical fiber, and light-diffusing particles affixed to a terminal end of the optical fiber.

2. The illuminator of claim 1, wherein the light-diffusing particles are optically transparent solid particles of regular or irregular geometry.

3. The illuminator of claim 2, wherein the particles include at least one selected from solid spheres, ellipsoids, cubes, polygons, tetrahedrons and mixtures thereof.

4. The illuminator as in claim 1, further comprising a bonding material for affixing the light-diffusing particles to the terminal end of the optical fiber.

5. An optical illuminator comprising an optical fiber having a light-emitting terminal end, and an optically transparent light-diffusion medium affixed to said terminal end of said optical fiber, wherein said light diffusion medium is comprised of a bonding material, and solid light-diffusing particles dispersed in said bonding material.

6. The illuminator as in claim 4 or 5, wherein the particles are symmetrically or asymmetrically dispersed in the bonding material.

7. The illuminator as in claim 4 or 5, wherein the particles are present in an amount sufficient to achieve a light diffusion profile which is at least about 1.25 times the light diffusion profile of a comparable optical fiber having no light-diffusing particles affixed to a terminal end thereof.

8. The illuminator as in claim 4 or 5, wherein the light-diffusing particles are present in an amount of less than about 90 vol. %.

9. The illuminator as in claim 4 or 5, wherein the light-diffusing particles are present in an amount of less than about 60 vol. %.

10. The illuminator as in claim 4 or 5, wherein the light-diffusing particles are present in an amount of less than about 30 vol. %.

11. The illuminator as in claim 1 or 5, wherein the light-diffusing particles have an average particle diameter of between about 1 μm to about 375 μm.

12. The illuminator as in claim 1 or 5, wherein the light-diffusing particles have an average particle diameter of less than 10.0 μm.

13. The illuminator as in claim 1 or 5, wherein the light-diffusing particles have an average particle diameter of between about 1.0 μm to about 10.0 μm.

14. The illuminator as in claim 13, wherein the light-diffusing particles have an average particle diameter of between about 5.0 μm to about 10.0 μm.

15. The illuminator as in claim 1 or 5, wherein the light-diffusing particles have an average particle diameter which is less than about one-half the diameter of the optical fiber.

16. The illuminator as in claim 1 or 5, wherein the light-diffusing particles have an average particle diameter which is less than about one-fourth the diameter of the optical fiber.

17. The illuminator as in claim 4 or 5, wherein the bonding material is optically transparent and wherein the difference between the indices of refraction of the bonding material and optical fiber is less than about 15%

18. The illuminator as in claim 17, wherein the difference between the indices of refraction of the bodning material and optical fiber is less than about 5%.

19. The illuminator as in claim 4 or 5, wherein the bonding material has an index of refraction which is substantially the same as the index of refraction of the optical fiber such that Fresnel reflection at an interface between the bonding material and the optical fiber is less than about 5%.

20. The illuminator as in claim 19, wherein the Fresnel reflection is less than about 1%.

21. The illuminator as in claim 5, wherein the terminal end of the optical fiber and/or the bonding material is shaped.

22. The illuminator as in claim 5, wherein the terminal end of the optical fiber forms an angle with respect to the longitudinal axis of the optical fiber, and wherein the light diffusion medium has a planar, convex or concave exterior surface.

23. The illuminator as in claim 22, wherein the angle is between about 45° to about 90°

24. A surgical light system comprising a light source, and an optical probe optically coupled to the light source, wherein said optical probe comprises an optical illuminator as in claim 1 or 5.

25. A method of making an optical illuminator which comprises affixing light-diffusing particles to a terminal end of an optical fiber.

26. A method as in claim 25, which wherein said step of affixing the light-diffusing particles comprises (i) dispersing the particles in a bonding material to form a light diffusion medium (LDM), and thereafter (ii) applying a mass of the LDM to the terminal end of the optical fiber.

27. The method of claim 26, wherein step (i) is practiced by dispersing solid light-diffusing particles in a liquid bonding material.

28. The method of claim 27, wherein step (ii) is practiced by applying a mass of the liquid bonding material to the terminal end of the optical fiber and thereafter (iii) allowing the bonding material to solidify.

29. The method of claim 26, which comprises shaping the LDM and/or terminal end of the optical fiber.

30. The method of claim 26, wherein the particles are dispersed symmetrically or asymmetrically in the bonding material.
